(19) United States
(12) Patent Application Publication
(10) Pub. No.: US 2008/0192929 A1
(43) Pub. Date: Aug. 14, 2008

(54) Secure communication unit

(75) Inventors: Harry Knechtel, Augsburg (DE); Marco Hofmann, Munchen (DE); Gunnar Hettstedt, Markt Schwaben (DE); Marc Lindlbauer, Munchen (DE)

Correspondence Address: K.F. ROSS P.C., 5683 RIVERDALE AVENUE, SUITE 203 BOX 900, BRONX, NY, 10471-0900, US

(73) Assignee: SECURITY NETWORKS Aktiengesellschaft

(21) Appl. No.: 12/069,575

(22) Filed: Feb. 11, 2008

(30) Foreign Application Priority Data
Feb. 13, 2007 (EP) 07003042.4

(51) Int. Cl. H04L 9/00

(52) U.S. Cl. 380/44

(57) ABSTRACT

A vehicle having electrical or electronic components connected to a communication network also has a security unit connected to the network. This security unit in turn has at least one cryptography module connected to the communication network and with which cryptographic codes are generated, stored, managed or processed and at least one coordination module for the coordination of individual modules within the security unit.

### FIELD OF THE INVENTION

The present invention relates to a secure communication unit. More particularly this invention concerns such a unit for use in a vehicle, e.g an aircraft or a watercraft, or even in a production line or in a remotely controlled system.

### BACKGROUND OF THE INVENTION

Such a system (e.g. a vehicle) customarily has a plurality of electrical or electronic components, where the components or their control units can be connected to one another via a communications network, thereby forming an interconnected communications system. A communications network within the context of the invention refers especially to a bus system, e.g. a bus system in an automobile, an aircraft, or a ship, or a bus system or network for machines in production lines or for remotely controlled systems. Today, equipment of this type (e.g. motor vehicles) have at their disposal a plurality of controllers that can be configured as programmable control devices and that are to an ever-increasing extent being interconnected with their environment. For this reason, efforts are being made to ensure the integrity and authenticity of data from such control devices. In such efforts, the approach of using cryptographic methods to secure the integrity and authenticity of data is generally known. In vehicles, the process of applying cryptographically secured protocols to safely transport data to vehicles in the manufacturing plant and in the field is already known. Such known methods are software-based and run on processors that have no memory areas or have memory areas that are insufficiently cryptographically secured. Moreover, processors of this type do not possess the necessary processing capacity for complex cryptographic protocols and computing operations.

### OBJECTS OF THE INVENTION

It is therefore an object of the present invention to provide an improved secure communication unit.

Another object is the provision of such an improved secure communication unit that overcomes the above-given disadvantages, in particular that will function reliably and rapidly to ensure a high level of security.

### SUMMARY OF THE INVENTION

To attain this object, the invention proposes a security unit (secure communication unit), e.g. for a vehicle, aircraft, ship, or the like, that has at least one cryptography module (crypto unit) with which cryptographic codes are generated, stored, managed and/or processed, and at least one coordination module for the coordination of individual modules within the security unit. The cryptography module integrated into the security unit generates cryptographic codes, e.g. symmetrical or asymmetrical codes. In this manner, data received from another module via an interface can be encrypted and/or signed. In addition, with the cryptography module, data received from another module via an interface can be decoded and/or signatures verified or analyzed. The security unit also has at least one coordination module for the coordination and communication of the individual modules within the security unit. The coordination module manages the hardware resources, assigns these resources to applications, and ensures communication between the modules of the security unit and/or controls the modules. In this form, the coordination module ensures that the individual modules within the security unit can be operated without mutually influencing one another, and that in the event of a compromise, the compromised module is isolated, separating it from the remaining connected modules. Authentication is then performed via the cryptography module. The coordination module ensures the fail-safe status of the security unit of the invention. According to the preferred embodiment, the security unit is equipped with at least one programming module, via which the security unit, or one or more modules of the security unit, can be programmed, e.g. via an external system. The cryptography module is particularly preferably configured as a hardware module. It is also advantageous for the coordination module and/or the programming module to be configured as hardware modules.

The security unit of the invention can be intended, e.g. for an interconnected communications system, e.g. for a vehicle, aircraft, ship, etc., or can be integrated into such a communications system. Such an interconnected communications system can be composed of a plurality of controllers for individual electrical and/or electronic components that are connected to one another via a communications network, e.g. a bus. It is also possible for the security unit of the invention to be connected to the remaining controllers via the communications network. Furthermore, the security unit can be equipped with an internal communications module to allow the security unit to communicate with one or more controllers (electronic controller) of the interconnected communications system. This internal communications module can (optionally) be downloaded via the programming module.

The invention is based upon the recognition that the security within an interconnected communications system that has a plurality of electrical or electronic devices with corresponding controllers is significantly increased if a security unit is integrated into this communications system that especially has a cryptography module in hardware form, e.g. ASIC or FPGA. The cryptography unit generates and stores cryptographic code material in a secure manner. The cryptography module also securely and rapidly executes cryptographic operations and stores data. The coordination module ensures the fail-safe and efficient management of the described functions, and isolation of the modules that are connected to the communications module should a module become compromised, with the isolation of the compromised module being effected by blocking access to the communications module. The programming module ensures the secure downloading of modules, allowing a security unit to be adapted to the requirements of different application environments and, e.g. vehicle manufacturers.

The described possibility of integrating a security unit into an interconnected communications system represents one possible embodiment of the invention. However, the security unit of the invention can also be operated alone or independently of such a communications system, in other words in “stand-alone mode.” Within the context of the invention this means that the security unit communicates not with an interconnected communications system (directly) via, e.g. an internal communications module, but, e.g. with a processor that is not itself part of the security unit. Such communication can be conducted via the processor communications module to be described in what follows, which can also be integrated into the security unit.

In the preferred embodiment, the security unit therefore consists at least of the cryptography unit implemented in hardware form, the coordination module implemented in hardware form, the programming module implemented in hardware form, and the internal communications module that is optionally programmable following authentication via the cryptography unit.

According to a further proposal of the invention, the security unit has at least one external communications module for communication between the security unit and one or more external devices. An external device is a device that is not integrated into the interconnected communications system. The security unit is therefore equipped with the (additional) communications module for communicating with systems outside the interconnected communications system, with the module being programmed via the cryptography module following authentication.

In a further optional embodiment, the security unit can have at least one processor communications module for communication between the security unit and at least one external processor. Thus the security unit can be connected to another processor via this internal processor communications module that can be programmed via the cryptography unit following authentication. The security unit also makes it possible to load additional modules into the security unit via the cryptography module following authentication, and to log these into the coordination module.

The internal communications module can be configured as a hardware module or as a software module. It is also possible for the external communications module to be configured as a hardware module or a software module. Finally, the processor communications module can be configured as a hardware module or a software module.

The internal communications module, the external communications module, the programming module and/or the processor communications module are connected to the cryptography unit via the coordination module, or access the cryptography unit via the coordination module.

Within the scope of the invention a secure cryptographic anchor of confidence can therefore be created in a vehicle, under the sole control, for example of the automobile manufacturer, which lends full effectiveness to cryptographic processes and their applications and is capable of executing cryptographic operations at sufficient speed in order to ensure security based upon cryptographic functions. With this, security can be ensured especially during time-critical situations in the vehicle. It can also include rapid conveyor belt processes for the cost-effective production of vehicles, rapid servicing processes for minimizing maintenance costs, vehicle-to-vehicle communication, and online access within vehicles. The invention is further based upon the knowledge that, e.g. in the field of vehicles, aircraft and ships, special requirements in terms of the application environment must be fulfilled.

### BRIEF DESCRIPTION OF THE DRAWING

The above and other objects, features, and advantages will become more readily apparent from the following description, reference being made to the accompanying drawing in which:

FIG. 1 is a simplified block diagram of an interconnected communications system with a security unit according to the invention; and

FIG. 2 a schematic view of a detail of the system of FIG. 1.

### SPECIFIC DESCRIPTION

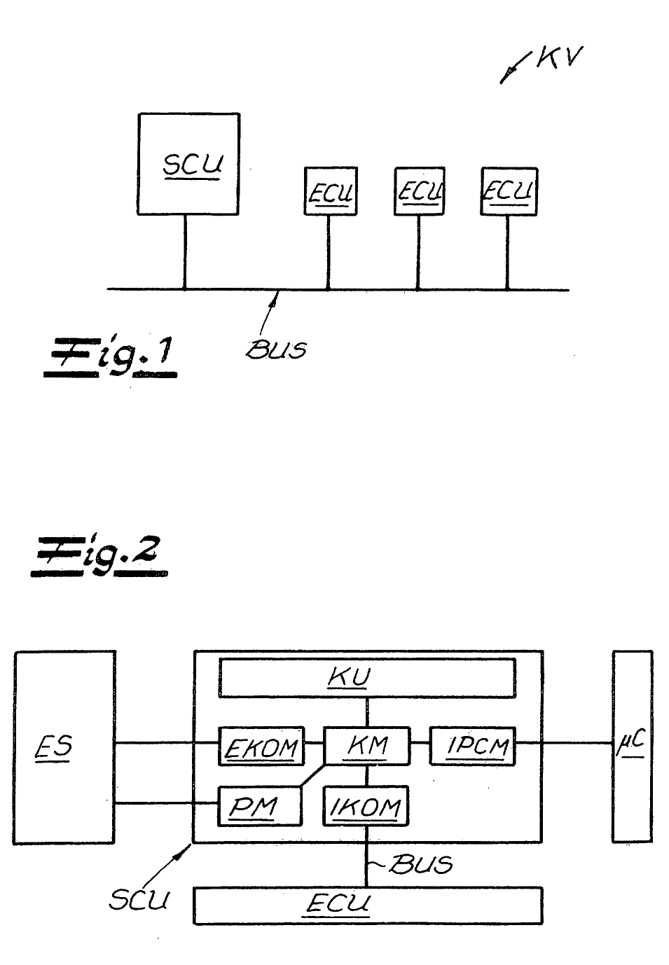

As seen in the drawing, an interconnected communications system KV for a device is shown that has a plurality of electrical and/or electronic components. This device can, for example, be a motor vehicle. Each of the individual electrical or electronic components has a controller ECU. These individual controllers ECU are connected to one another via a bus communications network that in the illustrated embodiment is configured as a bus system. Such a vehicle bus may be a CAN bus, for example. In the illustrated embodiment shown, a security unit SCU is integrated into this interconnected communications system KV that—like the remaining controllers—is connected to the bus system. This is shown schematically in FIG. 1. However, the security unit SCU can also be operated alone or without the represented communications system, i.e. in “stand-alone mode.”

The structure and functioning of this security unit SCU of the invention are illustrated in detail in FIG. 2.

This security unit SCU, which is connected to the vehicle bus, is equipped with a cryptography module KU, a coordination module KM, a programming module PM, and an internal communications module IKOM. The cryptography module KU, the coordination module KM and the programming module PM are each configured as hardware. The internal communications module IKOM is optionally provided, and can, e.g. be downloaded via a programming module PM.

An external communications module EKOM and a processor communications module IPCM are also integrated into the security unit SCU in the illustrated embodiment.

The functional center of this security unit SCU is the cryptography unit or the cryptography module KU, configured as a hardware module, with which cryptographic codes are generated, stored, managed and/or processed. The cryptography unit KU provides a secure environment for the generation and management of cryptographic code material. Secure storage areas are also provided. These secure storage areas are protected against unauthorized reading and writing of any data, but especially cryptographic codes. These storage areas can also be configured in terms of access to and management of the data stored there. For instance, it is possible to control whether such data can be re-exported, or are to be used only within the security unit.

With this, the cryptography unit KU is capable of generating random strings of numbers in configurable lengths and/or symmetrical codes in configurable lengths and/or asymmetrical codes in configurable lengths, in response to internal commands from the security unit. The cryptography unit KU is therefore equipped with a generic interface. In addition, configurable algorithms are implemented, i.e. the cryptography module KU can be configured with respect to the algorithms via data input, the generic interface remaining the same on the outside. In this manner, random data can be encrypted or electronically signed symmetrically or asymmetrically, or a fingerprint of the data can be calculated. The cryptography unit is further equipped with an interface via which it can be connected to a PKI (public key infrastructure). Thus an asymmetrical code pair can be reliably generated and stored as described, and a certification query for this PKI can be exported. In this connection, the cryptography module KU is capable of exporting certification queries and importing certificates. Furthermore, the cryptography unit KU is capable of protecting storage areas outside the security unit SCU against reading and writing access from outside the security unit. The cryptography module KU verifies electronic signatures (symmetrical and asymmetrical), including an optional certificate chain. In addition, the cryptography unit KU can provide a secured time. Because the cryptography unit KU is configured as a hardware module, it cannot be programmed from the outside without authorization. It is also optionally resistant to hardware attacks.

The coordination module KM, also shown in FIG. 2, is also part of the security-relevant core, along with the cryptography module KU, and ensures that the individual modules are operated reliably within the security unit without mutually influencing one another. In the event of a compromise, the coordination module KM isolates the compromised module from the remaining connected modules. In this manner, the coordination module, in its function as the central SCU communications interface, is able to suppress communication to and from the compromised module. The coordination module KM manages the hardware resources of the security unit SCU and assigns them to the respective modules or applications. To the extent necessary, the coordination module KM safeguards communication between the individual modules of the security unit.

Also important within the scope of the invention is the (optional) internal communications module IKOM. In this context, internal refers to communication within the interconnected communications system KV, i.e. communication between the security unit SCU and individual controllers ECU of a communications system. These control units ECU can be constituent elements, e.g. of corresponding vehicle components, or can assigned to such vehicle components. The internal communications module IKOM preferably implements bidirectional communication between the security unit SCU and other control devices ECU of the interconnected communications system KV. If a controller ECU is itself equipped with a corresponding security unit, and therefore a plurality of security units are integrated into a communications system, then an authentic data exchange that is protected against manipulation is possible between these security units via a protocol. Data exchange may also optionally be confidential. In this connection, FIG. 2 demonstrates that for the application of cryptographic methods, the internal communications module IKOM accesses the cryptography unit KU via the coordination module KM. It is optionally possible to configure the internal communications module IKOM to “eavesdrop” on certain data being transferred within the communications system, where it can then be provided that these data are stored in the secure area of the cryptography module KU.

While the operated internal communications module IKOM implements communication within the interconnected communications system, the external communications module EKOM that is also provided enables data communication between the security unit of the communications system and an external system, e.g. a system connected outside the vehicle or not connected to the bus. Such an external system ES can be, for example, a testing device or a temporarily connected server. In this case the connection set-up is authentic, i.e. a connection is established only when the external communications module EKOM has authenticated the external system ES with the help of the cryptography module KU. Optionally, the security unit SCU may also authenticate itself to the external system ES through the external communications module EKOM. Further, the option exists to transfer the transmitted, authenticated data, encrypted as needed. In this, the authentication of the data can also be coupled to the authentication of the connection set-up. Moreover, it is possible for the external communications module EKOM to be equipped with one or more filters that determine whether or not to forward data. An external communications module EKOM stores the authentication data from a connection.

A further essential component of the security unit of the invention is the programming module PM shown in FIG. 2. With this module, configurable access to storage areas of the security unit is possible, so that modules and data can be downloaded. Programming access is authenticated and achieved via an external system ES. This is indicated in FIG. 2 by the connection between the external system ES and the programming module PM, with the programming module PM in turn being connected to the coordination module KM and via this coordination module KM to the remaining modules of the security unit. The programming module also verifies the authenticity and integrity of downloaded modules and data.

Finally, FIG. 2 demonstrates that the security unit can be equipped with an (optional) processor communications module IPC that enables bidirectional IPC communication between the security unit SCU and another processor. In this manner, a security unit SCU can make the cryptographic services of the cryptography unit KU available to another processor μC via a protocol. The processor depicted in the illustrated embodiment in FIG. 2 is a microprocessor μC.

In a modified embodiment (not shown), the security unit communicates not (directly) with an interconnected communications system, but, e.g. via the processor communications module IPCM, with a processor that can then optionally transmit information/data. In such cases, which are referred to in the invention as the “stand-alone mode,” the internal communications module IKOM can optionally be dispensed with.

We claim:

1. A security unit comprising:
at least one cryptography module connected to the communication network and with which cryptographic codes are generated, stored, managed or processed; and
at least one coordination module for the coordination of individual modules within the security unit.

2. The security unit defined in claim 1 wherein the cryptography module generates cryptographic codes in the form of symmetrical or asymmetrical codes or data received from another module via an interface can be encrypted or signed or data received from another module via an interface can be decoded and/or signatures verified or analyzed.

3. The security unit defined in claim 1 wherein, in case of comprise of one or more modules, the coordination module isolates the compromised module with respect to one or more of the other modules.

4. The security unit defined in claim 1, further comprising
at least one programming module by means of which the security unit or a module of the security unit can be programmed.

5. The security unit defined in claim 1, further comprising
at least one external communications module for communication between the security unit and one or more external devices not integrated into the interconnected communications system.

6. The security unit defined in claim 1, further comprising
at least one processor communications module for communication between the security unit and at least one external processor.

7. The security unit defined in claim 1, further comprising
a communication network of a vehicle;
a communication network; and
a plurality of controllers connected via the communication network with the security unit.

8. The security unit defined in claim 7 wherein the security unit has an internal communications module for communication with the controllers via the communication network.

9. The security unit defined in claim 7 wherein communication network is a bus system.

10. The security unit defined in claim 1 wherein the cryptography module is hardware.

11. The security unit defined in claim 4 wherein the coordination module or the programming module is hardware.

12. The security unit defined in claim 1, further comprising:
an internal communication module;
an the external communication module;
a programming module; and
a processor communication module, at least one of which communicate with the cryptography module via the coordination module.

13. In combination with a vehicle having
electrical or electronic components;
a communication network; and
a security unit connected to the network and comprising
at least one cryptography module connected to the communication network and with which cryptographic codes are generated, stored, managed or processed; and
at least one coordination module for the coordination of individual modules within the security unit.
